(19) United States
(12) Patent Application Publication
(10) Pub. No.: US 2024/0354151 A1
(43) Pub. Date: Oct. 24, 2024

(54) SYSTEM AND METHOD FOR CONTROLLING JS SCRIPTS ACCESS TO DOM/APIS

(71) Applicant: Forter Ltd, New York, NY (US)

(72) Inventor: Ori Argov, Tel Aviv (IL)

(21) Appl. No.: 18/684,407

(22) PCT Filed: Aug. 17, 2022
(86) PCT No.: PCT/US2022/040559

§ 371 Date: Feb. 16, 2024

Related U.S. Application Data
(60) Provisional application No. 63/235,324, filed on Aug. 20, 2021.

(51) Int. Cl. G06F 9/48

(52) U.S. Cl. CPC G06F 9/48

(57) ABSTRACT

According to some embodiments. a management system is configured to host a secure execution environment. Browser scripts and API requests can be evaluated in the secure execution environment to validate their functions in terms of security and/or data privacy. In further embodiments. the system is configured to validate operation via a proxy layer or hooking all of the function controls so that whenever is requested (e.g., outside resources or data). the system is configured to track what is requested and what operations are done. For example. once proper function has been validated in terms of data privacy and/or security. the candidate script. API. etc., can be signed as valid (e.g., via a secure hash). The secure hash can be used in subsequent operation to ensure that the script. API, etc. matches a known valid version and function.

### RELATED APPLICATIONS

This Application claims priority under 35 U.S.C. § 119 to U.S. Provisional Application Ser. No. 63/235,324, filed Aug. 20, 2021, entitled “SYSTEM AND METHOD FOR CONTROLLING JS SCRIPTS ACCESS TO DOM/APIS” which is incorporated herein by reference in its entirety.

### BACKGROUND

Web browsers represent a high value target for malicious actors because sensitive data passes or is accessed and becomes available through them. Web browsers can be used for almost any online activity, including casual shopping, enterprise management, banking, even military operation or communication. Web browsers have become the primary vehicle people use to access network-connected systems. Browsers have a long history of vulnerabilities that have provided attackers with a lucrative and near-endless supply exploits.

### SUMMARY

The inventors have realized that in many conventional systems, JavaScript (JS) and the browser have very limited application programming interfaces (“APIs”) and controls over permissions and access to the document object model “DOM” and browser APIs. In contrast. mobile application software development kits (“sdks”) and frameworks include architecture for permissions to any APIs that play a role in ensuring user data security and privacy. However, the JS and associated functionality in various browsers remain very limited. Various aspects of the present disclosure resolve this limitation by integrating new functionality that enables improved data security and privacy. Further embodiments include and/or are based on new architecture for the browser that enhances security and privacy.

According to some embodiments, a management system is configured to host a secure execution environment. Browser scripts and API requests can be evaluated in the secure execution environment to validate their functions in terms of security and/or data privacy. For example, once proper function has been validated in terms of data privacy and/or security, the candidate script, API, etc., can be signed as valid (e.g., via a secure hash). The secure hash can be used in subsequent operation to ensure that the script, API, etc. matches a known valid version and function.

In further embodiments, the system is configured to validate operation via a proxy layer or hooking all of the function controls so that whenever is requested (e.g., outside resources or data), the system is configured to track what is requested and what operations are done. In this context, the system can identify any suspect, invalid, and improper activity whether the activity implicate security or data privacy concerns. For example, data access not needed in the API context would be flagged invalid. In addition, the system is configured to allow users to define specific operations or accesses that they want to allow or not allow. The system can monitor for some known subset of functions by default and augment that subset with user defined targets.

According to one aspect, a system for managing script execution by a browser, the system comprises at least one processor, memory operatively coupled to the at least one processor, the at least one processor when executing configured to instantiate a sandboxed environment including at least a proxy layer for managing resource requests, execute the browser within the sandboxed environment and respective site code, capture information on any resource requests made by the browser, validate operation and any resource requests based on a system defined security or privacy policy, and generate a secure signature for the browser and/or script or a validation log of the resource requests made by the browser, responsive to validation of operation.

According to one embodiment, the system is further configured to generate a secure signature for scripts under test responsive to validation of operation. According to one embodiment, the system is further configured to generate a secure signature for the browser responsive to validation of operation. According to one embodiment, the at least one processor is further configured to evaluate any access points targeted, resource requested, communication calls, operating system requests, privilege change, memory requests inconsistent with prior operation, as specified by the security or the privacy policy. According to one embodiment, the at least one processor is further configured to evaluate any access points targeted, resource requested, communication calls, operating system requests, privilege change, memory requests inconsistent with prior operation, as defined by default system parameters.

According to one embodiment, at least one processor is configured to obscure any operations executed under the management of the proxy layer. According to one embodiment, the at least one processor is configured to return results of new operations in the site code based on specification in any original code of the new operations. According to one embodiment, the at least one processor is configured to analyze any code associated with a new operation in associated site code based on known vulnerability exploits and custom execution targets (e.g., customized based on the script being analyzed). According to one embodiment, the proxy layer is further configured to manage execution of any operations performed by the site code based on javascript, document object model (“DOM”) specification, network operations. According to one embodiment, the at least one processor is configured to analyze new operations in the site code using similarity to historic operations, including similarity to access points, DOM element access, operating system calls, and network requests.

According to one aspect, a computer implemented method for managing script execution by a browser, the method comprising, instantiating, by the at least one processor, e a sandboxed environment including at least a proxy layer for managing resource requests, executing, by the at least one processor, the browser within the sandboxed environment and respective site code, capturing, by the at least one processor, information on any resource requests made by the browser, validating, by the at least one processor, operation and any resource requests based on a system defined security or privacy policy, and generating, by the at least one processor, a secure signature for the browser and/or script or a validation log of the resource requests made by the browser, responsive to validation of operation.

According to one embodiment, the method further comprises generating a secure signature for scripts under test responsive to validation of operation. According to one embodiment, the method further comprises generating a secure signature for the browser responsive to validation of operation. According to one embodiment, the method further comprises evaluating any access points targeted, resource requested, communication calls, operating system requests, privilege change, memory requests inconsistent with prior operation, as specified by the security or the privacy policy. According to one embodiment, the method further comprises evaluating any access points targeted, resource requested, communication calls, operating system requests, privilege change, memory requests inconsistent with prior operation, as defined by default system parameters.

According to one embodiment, the method further comprises obscuring any operations executed under the management of the proxy layer. According to one embodiment, the method further comprises returning results of new operations in the site code based on specification in any original code of the new operations. According to one embodiment, the method further comprises analyzing any code associated with a new operation in associated site code based on known vulnerability exploits and custom execution targets (e.g., customized based on the script being analyzed). According to one embodiment, the method further comprises managing execution of any operations performed by the site code based on javascript, document object model (“DOM”) specification, and network operations. According to one embodiment, the method further comprises analyzing new operations in the site code using similarity to historic operations, including similarity to any one of: access points, DOM element access, operating system calls, or network requests.

According to one aspect, a system for managing script execution by a browser is provided. The system comprises at least one processor; a memory operatively coupled to the at least one processor; the at least one processor when executing configured to: instantiate a sandboxed environment including at least a proxy layer for managing resource requests; execute the browser within the sandboxed environment and respective site code; access validation information associated with the browser and respective scripts; verify the browser and respective script against the validation information; prevent execution of the browser or browser functionality responsive to failed verification; and permit execution of the browser or browser functionality response to verification.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments. and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of management system, according to one embodiment;

FIG. 2 is a block diagram of an example special purpose computer system improved by the functions and/or processes disclosed herein;

FIG. 3 is a block diagram of an example system and flow, according to one embodiment;

FIG. 4 is a block diagram of an example system and flow, according to one embodiment.

### DETAILED DESCRIPTION

Various aspects of the disclosure describe architecture and implementation to improve the security of browser execution, including execution based on javasscript (“JS”). To provide an example context, a problem that embodiments in the disclosure address is based on a conventional website. In one example, the website can be hosted by an e-commerce merchant, where the website includes third party scripts. In this context, the merchant likely has very little knowledge or control over what the third party scripts are accessing. This leads to suspicion, lengthy security evaluation processes, tension between the need of the third party to preserve trade secrets and the website's need to protect its users (and by extension, itself).

Accordingly, various aspects enable a system to provide discovery, validation and ultimately control over candidate scripts (e.g., JS) that any website wishes to include. According to one embodiment, the system is configured to execute a sandboxed and audited environment in which browser execution can be controlled. According to various embodiments, the environment is managed so that any relevant DOM/API access is “hooked” (or “proxied”), and the hooked execution is configured to monitor the behavior of any JS script being executed by the browser. Various embodiments are configured to hook capture specific APIs and properties for exfiltration, including reporting on operations, targets, modification (attempts), discovery attempts, communication requests, etc.

Various implementations can be executed to provide the sandboxed and audited environment including various proxy based implementations. Some example proxy implementations include:
Executing modified (e.g., compiled from source) browsers-where execution by the browser is proxied on the native level (e.g., safest, possible for offline analysis). In some examples, a monitored version of the browser can be built to ensure only monitored/proxied executions are made.
An example includes the Chromium browser, which can be specially configured to securely execute various resources, and in further embodiments to ensure that the proxied execution cannot be detected or circumvented by, for example, JS code running in the browser. Another example includes the BRAVE browser. The various browsers can be configured, for example, to disable default permissions, including DOM functionality.
In some examples, resource execution occurs through defined proxies that specify targets and handlers, logging any requested execution(s), targets, modifications, etc. The logs can be configured to capture prior state of any modified data to ensure validity. Further examples, include prohibited targets that could be used to compromise the browser or environment. For example, various browsers can be configured to cause all third-party network requests to be blocked by default, unless allowed by the user and proxied object.
Proxy execution of any browser extension (e.g., offline analysis and possibly online analysis)
According to some examples, this approach involves a delivery method of the JS Proxy code (which can be expanded) to pages running in the secure environment. In one example, the system can be configured to simply inject a JS script with the logic, or in other examples, the system can be configured to stage processing including a set up stage to accomplish secure execution, which can include hooking relevant points during execution;
Execute JS Proxy Object wrapping relevant access points and APIs (for example, this approach can be implemented with any live website). Various example designs and pre-requisites can be implemented to ensure security and privacy. For example, the prerequisites can include that the hooking JS tag is the first to execute on the page, or is included inline in the HTML code of the main page (and not as an external downloaded JS resource etc.). In further example, this approach can also be implemented in an on-line setting in which only JS as part of the website is available (e.g., the execution environment is not entirely controlled). According to various embodiments, being first to load ensures that malicious scripts or even poor code does not mask its operation, concealing potential vulnerabilities, data leakage, or attacks. In further embodiments, the system leverages native browser capabilities for proxy execution (for example the known FIREFOX browser includes a proxy object that can be defined to handle any operation specifying an access point and/or interaction with an API), and defines novel proxy architecture to ensure privacy and security for any API or JS execution. Various known browsers have functions embedded to handle proxy execution.
Further, delivery of this code can be done server-side (if not by Browser Extension). In one example, the system provides a browser extension that is configured to protect functions, properties, and objects that can otherwise be exploited to construct attacks. In one embodiment, browser functions are wrapped with replacement versions that allow injection of a policy. For example, a simple policy can enforce the number of times data can be requested (e.g., or any functionality can be called) and get a valid result. When that threshold is exceeded the policy requires/returns an error or returns empty values. Another example is allow/deny execution/output based on the identity of the caller code origin. In various embodiments, the ability to control the execution environment enables hook/proxy access that remains hidden, and provides a more secure level than a JS Proxy object in the same execution context of the page.

The various methodologies above can be generated using virtual machines and images, operating system images, and/or images of builds of various browsers, among other options. Once the environment is properly set up, for example with browser extensions, configuration, etc., monitoring and/or control of third party scripts can be managed.

In various embodiments, the system is configured to execute dynamic analysis on JS requests and/or DOM access, in further embodiments the system can also execute static analysis on any script/process to map out code locations around access to said areas. In some embodiments, the system is configured to run a security/privacy audit on the behavior of any script, and in further example, various embodiments can employ the security/privacy audit when source code review or revelation is not available or possible. Unlike many conventional systems that do resolve security and/or privacy issues for JS script dynamically and statically, various embodiments described herein ensure an improved level of security and privacy. To the best of the inventors' knowledge there are no known automated tools for ensuring or gaining confidence in a third party JS code is not accessing APIs/data the site owner does not want to allow (for example form data containing users PII, such as email credit card numbers etc.). In the current environment, most JS providers obfuscate their code and refuse to provide details on execution. The result is a forced trust relationship that requires trust in the JS provider to not act maliciously or to not accidentally create vulnerabilities or leaks. According to various embodiments described herein, the management system can eliminate the trust requirement by providing technological implementation to evaluate any execution, and verify proper functionality.

According to one embodiment, the system is configured to enable a client website to decide to validate an iteration of a script or browser that has zero access to checkout forms (e.g., no “data scraping”), for example by a JS, by executing the browser and any associated operations in a test phase. If the system confirms that the script or browser passes the test phase (e.g., no logged scraping, no requests for inappropriate data, etc.), the system is configured to provide a “trust stamp” on the version of the script and/or browser. In one example, the version can be verified using a content hash, among other options. On subsequent review, if the script's hash matches a validated hash then the execution properties of the subsequently reviewed script and/or browser is known to be valid. Various browsers have functions embedded to handle securely accessing resources. For example, FIREFOX employs Subresource Integrity “SRI” to validate a secure hash on an accessed resource. The browser then can verify that resources they fetch (for example, from a content delivery network “CDN”) are delivered without unexpected manipulation. According to various embodiments, all major browsers that are available provide utilities that can be used to secure execution, for example, when analyzing validated operation with associated trust indicia. In another example, a hash mechanism can be employed as part of an inline script to secure operation. Content Security Policy (“CSP”) inline script can employ a sha-256 hash to secure options.

According to some embodiments, the system is configured to execute loaded scripts via proxy processes and/or a proxy layer in a test environment. The system can monitor all requests and areas accessed in the test environment. Logging of the scripts accessed and utilization can be analyzed to confirm security and/or privacy is respected. In one example, an administrative user can load scripts into the test environment, and the system generates a report on the areas being accessed, and the type of access being performed by each script. The report can be evaluated to ensure security and privacy requirements are met. Once validated, the report can then be presented with a “signed proof” of being data access safe (as defined by the administrative user). In further embodiments, the combination of a signed proof and cryptographic hash on any script provides assurance to installers or system administrators that a specific script being run within a browser is verified secure and privacy (e.g., based on the requirements defined in testing).

Further embodiments can include additional functions that can be executed securely wherein the functions imposed constraint on execution. Some embodiments can include defining scripts that are not allowed to call performance-expensive APIs (e.g., can be determined on estimated, anticipated utilization, and/or predefined lists, among other options), defining scripts that are not allowed to call other APIs (e.g., blacklisted sensitive APIs, APIs with potential security issues, etc.), and defining a script that cannot exceed using some % of CPU resources when loading a page, among other options.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising.” “having.” “containing.” “involving.” and variations thereof is meant to encompass the items listed thereafter and equivalents thereof as well as additional items. References to “or” may be construed as inclusive so that any terms described using “or” may indicate any of a single, more than one, and all of the described terms.

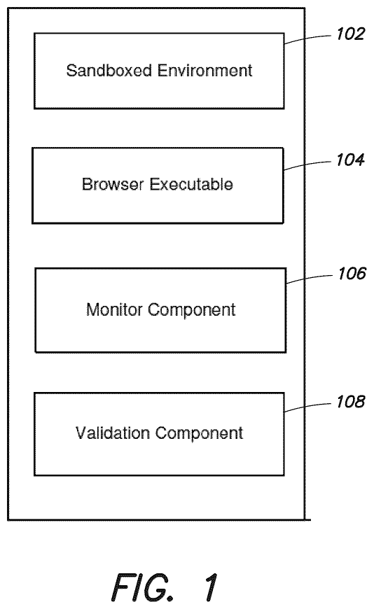

FIG. 1 is an example block diagram of a system for validating browser and/or script execution. According to some embodiments, the system can instantiate a plurality of components each configured to perform functions disclosure herein. In other embodiments, the system can perform the described functions without executing the various components.

According to one embodiment, the system 100 is configured to define a sandboxed execution environment 102. A sandboxed execution environment describes a security mechanism used to limit operations and/or execution of application and/or functions, and can also be used to isolate operating systems from other code, among other options. In some implementations, the system establishes a sandboxed environment to control operations of browser functionality and/or plugins, APIs, extensions, etc., of the browser application (e.g., 104 browser executable). For example, the system can include a browser application that is executed within the sandboxed environment.

Further embodiments can include a monitor component 106 that is configured to identify functions, call, etc., being executed by the browser application. The monitor component can be integrated into the sandboxed environment and form a proxy layer that manages various function calls and/or proxied hooks into the various functions, APIs, etc. called by the browser. For example, the monitor component can identify, track, and log targets of browser operations. The various targets can be evaluated based on potential data privacy issues, security threat, or vulnerability. In some embodiments, the monitor component can be used to build lists of function targets that the system can prevent from being called. For example, any function or target on form data can be suspect and closely monitored. Other examples include any API/function that directly or indirectly allows extraction of user-entered data (e.g., PII, financial data etc.). Additional examples included operations for browser/user fingerprinting and related APIs (these vary, but include webgl, webrtc, screen information, etc.). Still other examples include functions that are known to be costly (computationally) for site performance speed and user experience. In some embodiments,

Various conventional approaches fail to identify masked or concealed functions, and fail to identify suspect activity that occurs at or based on a request target. Various embodiments are configured to identify and/or prevent attempts to conceal data access or suspect activity based on proxied execution and/or by employing modified functions having safe/known behavior. In some examples the system can employ modified functions that take the place of unsecured versions. For example, in a test environment, function calls or other executables can be rewritten as proxied operations, and the proxied version can be monitored and report on its own operation. In another example, a proxy layer or wrapper object can operate as a gateway on functions, calls, requests, etc., passing through only ones that are valid, have appropriate targets, etc., and block or report on any operations with suspect or malicious targets. The proxied operations can also be configured to identify detection operations, including for example, operations configured to learn information on an execution environment. Some attacks are staged to discover then exploit, and can be separated in time and across multiple executables, plugins, extensions, etc. By identifying and blocking discovery operation, the system can improve over security approaches.

In some embodiments, the system can include a validation component 108 configured to determine that a function is secure and/or that an application is based on a known version. For example, the system can validate that a browser application is a known version via a secured hash. In other examples, the system can validate various substitute functions and/or functionality to ensure that secured operation cannot be circumvented. For example, the system can be configured to check if a certain JS function is similar to a native version supplied by the browser or detected modification by some JS code to add/remove logic. In other examples, “malicious” code can decide that a function that writes text into a form field (e.g., email, cc number) also triggers sending a network request with this data somewhere. The system is configured to detect and prevent the network request.

According to one embodiment, the system is configured to validate operation via these a proxy layer or hooking all of the function controls so that whenever is requested (e.g., outside resources or data), the system is configured to track what is requested and what operations are done. In this context, the system can identify any suspect, invalid, and improper activity. For example, data access not needed in the API context would be flagged invalid. In addition, the system is configured to allow users to define specific operations or accesses that they want to not allow. The system can monitor for some known subset of functions and augment that subset with user defined targets, so that the system does not need to compile a full report of everything that is being accessed-such an undertaking can be computationally prohibitive.

For example, a user can specify on the system that they want to prevent anything that has functions for, or like, DOM extraction, prevent any function that extracts information from forms, etc. In some embodiments, the system is configured to report on operations, functions, or accesses specified by the user (e.g., form access, API calls to form data, etc.).

In various embodiments, the system is configured to conceal proxied operations to ensure that scripts, codes, or functions is not attempting to cheat the system. For example, if a script can detect it is being monitored, the script can be coded with monitored behavior settings that appear valid, safe, and/or to respect data privacy, while having other functionality that is only executed in unmonitored environments. It is realized that not every user interaction leads to all the code being executed, not all the code need be executed in various conditions. Various embodiments can be configured to resolve this issue based on fuzzing. The target in fuzzing is to execute as many scenarios and code paths, including at random, as possible. Again, the system permits the user to define such scenarios that they believe are important or likely (e.g., ensure coverage of main flows—like the checkout flow or filling out the form). In addition, random fuzzing tests can be added to any default set of tests, any user specified test, etc. In conjunction with scenario based execution, the system can integrate static code analysis.

In various embodiment, the system is configured to control or manage the browser so that execution can be monitored and/or verified. In one example, the system provides a recompiled browser that integrates changes on the native level. In these settings, the system can guaranty that a given JavaScript has no direct way of figuring out whether any function is not native or hooked. When the execution environment is not managed or control such guarantees are more difficult.

### Extended Architecture: Real-Time Control and Governance

According to another aspect, an extension of the approaches described above can be integrated into an online system. For example, the approaches above can also be modeled as a real-time permission and access control system. According to some embodiments, the system can be configured to execute a subset of “hooks” or “proxies,” where the subset is known and verified to be safe to run for a live production website. Based on execution of the real-time permission and access control, various embodiments are configured to provide real time alerts and restrictions on third party JS code.

As has been demonstrated, JavaScript can be used to mount cache attacks and other malicious operations. Some approaches are available to circumvent these attacks. However, many conventional implementations focus on permissions and access and do not account for limiting execution or securing execution on other basis (e.g., based on performance limitations, among other options). Further conventional implementations describe a browser extension level as a proof of concept. Owing to the implementation, such an approach is not optimized or in many cases not capable for use in offline analysis and does not provide security at a browser native level layer. The inventors have realized that conventional implementation does not provide for securely concealing proxied execution. For example, known conventional approaches do not try to hide themselves very well. The result is that conventional proxy approaches can easily be detected and circumvented.

In some embodiments, the system executes a real-time control module configured to provide enhanced security in real-time. In further embodiments, the real-time JS control module yields additional security and optimization in further contexts: browser clients often complain about needing to include many third party JS scripts, when a few of them access the same data and APIs (but do slightly with different processing and need their own custom code to run on the site). The impact for this requirement comes both in terms of a JS performance impact, and an impact on data access management. Many conventional approaches seek to resolve this issue by pushing JS providers into some sort of consolidation, where JS providers are limited based on the fact that they are collecting the same data to take the needed data from one or more specified sources. The inventors have realized that this approach is often not possible and/or not feasible.

Thus, various embodiments of the system couple a caching layer with the JS proxy layer to enable JS script to take data from the cache rather than forcing an arbitrary consolidation that does not work in many conventional approaches. In one embodiment, the system implements a proxy for JS and to provide caching. For example, the system executes scripts to manage an option of caching on a first request, thus allowing the system to be more efficient. In one example, the system cache enables saving resources on costly browser APIs that would normally be called over and over. In further embodiments, the system is configured to optimize performance by accessing some data in the most efficient way possible (for example, using background threads to handle common data requests while preserving the ability of a main thread (e.g., UI) to continue to run without blocking or slowing). In one example, the system can employ WebWorker threads to more efficiently provide data access in a cache layer.

In still other embodiments, the system can implement full blown JS governance. For example, the system can be configured to map out which script (vendor) is trying to access which data. According to one embodiment, the system can be configured to perform a stacktrace analysis on the intercepted function call-site. For example, the system can include logic to locate interesting calling scripts vs. generic script layers (like jQuery).

In further embodiments, the system can use the knowledge of script and data access to manage all such requests according to a system defined budget. In various examples, the system can be configured to provide “budget” controls for APIs or data, etc. The budget can define access to data such that caches data use is maximized across APIs, scripts, etc. Further, the budget can limit and/or allocate processing across various tasks, so no vendor implementation overwhelms any environment.

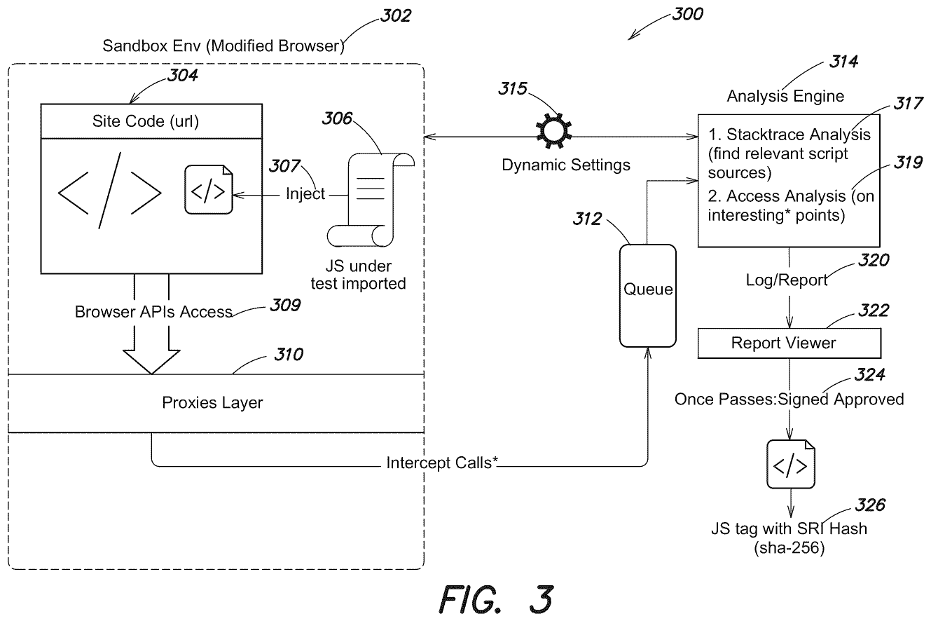

FIG. 3 is a block diagram of an example system and flow for secure execution of browser functions and respective processes. According to one embodiment, the system 300 can include a sandbox environment 302 for securely executing browser code and/or scripts (e.g., 306). According to some embodiments, site code can be accessed from within the sandbox environment to enable analysis of operations under test. For example, a JavaScript 306 can be imported into the environment and injected at 307 into the site code to evaluate its operation. During operation any calls, requests, and/or operations can be monitored.

According to one embodiment, the sandbox environment 302 is configured to monitor any browser API access that occurs (e.g., at 309). Such access can be managed via proxy layer 310 configured to intercept requests, calls, communication, etc. For example, the proxy layer 310 can be configured to manage JS, DOM, network operation so that the proxy layer can identify valid versus invalid access or requests and respond accordingly.

According to one embodiment, the proxy layer 310 is configured to intercept calls originating in the browser or APIs and feed those calls into a queue 312 for analysis. According to some embodiments, the system can include an analysis engine configured to validate or reject operations performed by code under test based on any dynamic settings 315 or known attack/invalid operations and/or targets. Various dynamic settings can be set on the system to permit analysis of various operations. System users can set specific dynamic settings according to operations and their known parameters. For example, the system users can define information on data access, specifying what requests or valid and what requests target invalid or inappropriate information. According to some embodiments, the dynamic settings can include target in handler information which can be analyzed by the analysis engine to validate operation (e.g., accessing known data source, accessing known functionality, etc.).

According to some embodiments, the analysis engine 314 is configured to analyze intercepted calls in queue 312 by executing stack trace analysis on relevant operations, data sources, data targets, etc. For example, at 317 the analysis engine can perform stack trace analysis to find relevant script sources in the script under test (e.g. 306). At 319 the analysis engine can execute analysis on access of the respective calls in queue 312. According to some embodiments, access analysis is performed on interesting points resulting or that are the targets of any script execution, function, call etc. Interesting points can be specified in the dynamic settings or can be based on known malicious targets for on known good targets, among other options.

Further examples of dynamic settings include limiting/focusing the scope of the audit functions. In various contexts, the burden or computation effort for monitoring everything being done is significant. Targeting the monitoring to sets of functions requested by any JS or APIs improves operations. In the event of suspect or dangerous activity, the system can expand monitoring to include additional functions to monitor, expand stack trace analysis on additional functions, etc., as part of the dynamic settings. In some embodiments, the dynamic settings include triggering custom access checks that the system does not execute by default or as pre-configured checks. In other examples, the user of the system can plug in their own module that detects something important to their space not covered by default or with preconfigured options. Still other options for dynamic setting include updates to the conditions and/or the parameters that trigger access warning/errors in the final report, updates to fuzzing patterns (e.g., expand parameters), trigger recording and replay of scripting user interactions with the page to elicit execution paths from the JS code under audit or analysis.

According to some embodiments, the analysis engine 314 is configured to log and/or report on the operations executed by any of the intercepted calls in queue 312. For example, at 320 the analysis engine generates a log or report on the intercepted calls any analysis done by stack trace, including relevant script sources, any access analysis including any interesting target points, and can include information on blocked functions, blocked access, among other options.

According to some embodiments, the analysis engine 314 can be configured to validate a script under test (e.g., 306) automatically based on the analysis engine not generating any indicia of malicious or bad action. In further embodiments, the analysis log can be presented the report viewer 322 for validation via system user. According to some embodiments, the report viewer can highlight suspect activity, including suspect access, suspect operations, suspect discovery attempts, etc. If a script under analysis passes the validation test, the system can be configured to generate a signature on the original script under test at 324. The system can integrate a JS tag within SRI hash of the original script under test for subsequent use in validating browser operation.

In some embodiments, system 300 can be configured to operate as an auditing system. The auditing system can evaluate candidate scripts, functions, etc. in the sandboxed environment and create tags for validated scripts. In some embodiments, the system 300 is configurable for what parameters and what calls to evaluate. For example, the dynamic settings can be set on a script by script basis allowing custom analysis for each script, and can also be configured by system users.

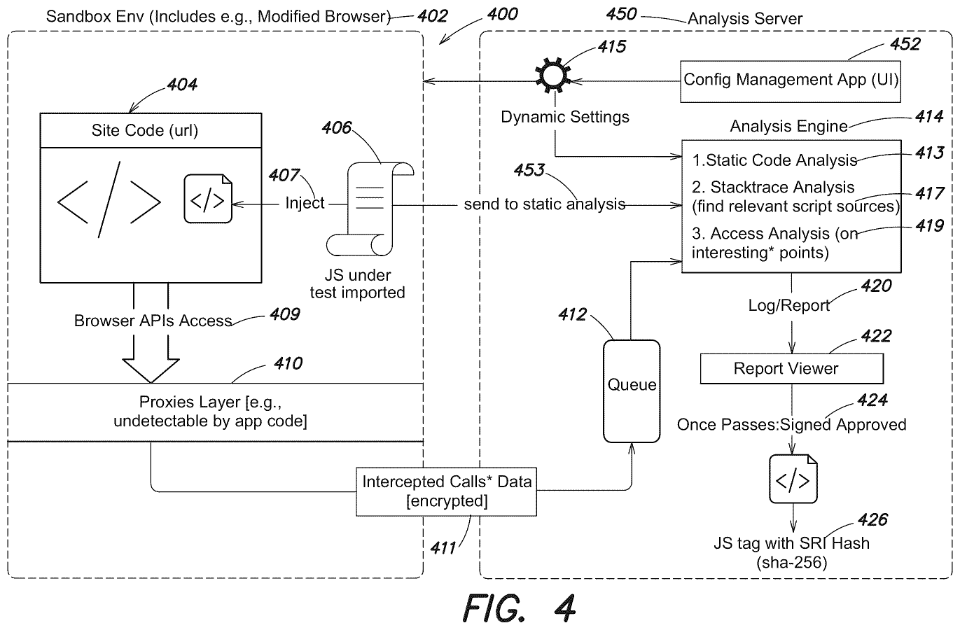

FIG. 4 is a block diagram of an example system and flow for secure execution of browser functions and respective processes. According to one embodiment, the system 400 can include a sandbox environment 402 for securely executing browser code and/or script that operates in conjunction with an analysis server 450. The analysis server can include configuration setting and functions to manage secure execution, analysis, and monitoring of browser functionality. According to one embodiment. The analysis service can include a configuration management application and/or user interface (e.g., 452) to access or establish settings for operation, including for example, dynamic settings 415.

According to some embodiments, site code can be accessed from within the sandbox environment to enable analysis of operations under test. For example, a script 406 (e.g., JS) can be imported into the environment and injected at 407 into the site code to evaluate its operation. During operation any calls, requests, and/or operations can be monitored.

According to some embodiments, the sandboxed environment 402 can include a customized browser to ensure that operation occurs securely. In other embodiments, the system can manage and/or monitor operations of conventional browsers, as discussed herein, improving their security and operation.
According to one embodiment, the sandbox environment 402 is configured to monitor any browser API access that occurs (e.g., at 409). Such access can be managed via proxy layer 410 configured to intercept requests, calls, communication, etc. For example, the proxy layer 410 can be configured to manage JS, DOM, network operation so that the proxy layer can identify valid versus invalid access or requests and respond accordingly.

According to one embodiment, the proxy layer 410 is configured to intercept calls originating in the browser or APIs and feed those calls (e.g., at 411) into a queue 412 for analysis. In some embodiments, the intercepted calls can be passed to the analysis server 450 and into any queue in encrypted formats to ensure secure operation.

According to some embodiments, the system can include an analysis engine 414 configured to validate or reject operations performed by code under test based on any dynamic settings 415, statis static analysis 413, and/or known attack/invalid operations and/or targets. In static analysis the purpose is to scan the code and figure out which API calls and Objects are potentially accessed from the code. For example, looking at constructs that end up calling window.X or navigator.Y (X and Y being functions or objects, such as window.screen of navigator.userAgent).

Various dynamic settings can be set on the system to permit analysis of various operations. System users can set specific dynamic settings 415 according to operations and their known parameters. For example, the system users can define information on data access, specifying what requests are valid and what requests target invalid or inappropriate information. In various embodiment, the dynamic settings can be used to limit/target the scope of the analysis for time/performance/priority reasons and/or extending the static analysis functionality with what the user cares about (for example, specifying objects/functions to search access for that are not inside window or navigator that are also interesting to them, among other options). According to some embodiments, the dynamic settings can include targets and handler information which can be analyzed by the analysis engine to validate operation (e.g., accessing known data source, accessing known functionality, attempt vulnerability access, attempted vulnerability functionality, etc.).

According to some embodiments, the analysis engine 414 is configured to analyze intercepted calls in queue 412 by executing stack trace analysis on relevant operations, data sources, data targets, etc. For example, at 417 the analysis engine can perform stack trace analysis to find relevant script sources in the script under test (e.g. 406). At 419 the analysis engine can execute analysis on access of the respective calls in queue 412. As part of the operations performed by the analysis engine 414, static analysis can be executed at 413, based on communication of the script under test (e.g., 406) at 453 to the analysis server 450 and/or engine 414.

According to some embodiments, access analysis is performed on interesting access points resulting or that are the targets of any script execution, function, call etc. Interesting points can be specified in the dynamic settings or can be based on known malicious targets, or on known good targets, among other options.

According to some embodiments, the analysis engine 414 is configured to log and/or report on the operations executed by any of the intercepted calls in queue 412. For example, at 420 the analysis engine generates a log or report on the intercepted calls any analysis done by stack trace, including relevant script sources, any access analysis including any interesting target points, and can include information on blocked functions, blocked access, among other options.

According to some embodiments, the analysis engine 414 can be configured to validate a script under test (e.g., 406) automatically based on the analysis engine not generating any indicia of malicious or bad action. In further embodiments, the analysis log can be presented the report viewer 422 for validation via system user. According to some embodiments, the report viewer can highlight suspect activity, including suspect access, suspect operations, suspect discovery attempts, etc. If a script under analysis passes the validation test, the system can be configured to generate a signature on the original script under test at 424. The system can integrate a JS tag within SRI hash of the original script under test for subsequent use in validating browser operation.

In some embodiments, system 400 can be configured to operate as an auditing system. The auditing system can evaluate candidate scripts, functions, etc. in the sandboxed environment and create tags for validated scripts. In some embodiments, the system 400 is configurable for what parameters and what calls to evaluate. For example, the dynamic settings can be set on a script by script basis allowing custom analysis for each script, and can also be configured by system users. In still other embodiments, the system can operate in a validation mode, where scripts having tags that include hash values can be confirmed as safe for execution, installation, etc. In some embodiments, the system can include monitoring processes, including those that can be separately accessed, installed, etc. an execution location (e.g., user device, user environment, audit environment, audit device, etc.) to continuously, periodically, a-periodically, monitor that a given script matches its validated signature information.

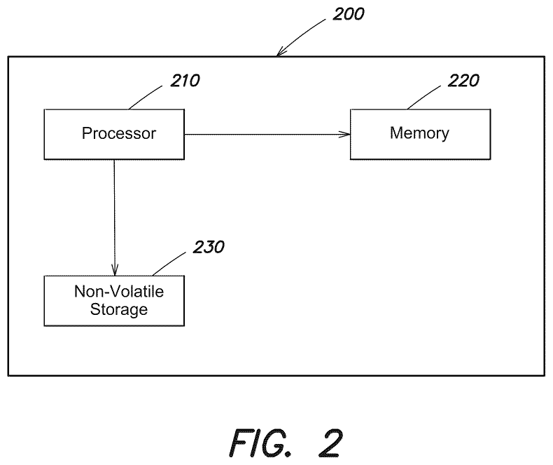

Additionally, an illustrative implementation of a special purpose computer system 200 that may be specially programmed to be used in connection with any of the embodiments of the disclosure provided herein is shown in FIG. 2. The computer system 200 may include one or more processors 210 and one or more articles of manufacture that comprise non-transitory computer-readable storage media (e.g., memory 220 and one or more non-volatile storage media 230). The processor 210 may control writing data to and reading data from the memory 220 and the non-volatile storage device 230 in any suitable manner. To perform any of the functionality described herein (e.g., secure execution, proxied execution, sandboxed execution, etc.), the processor 210 may execute one or more processor-executable instructions stored in one or more non-transitory computer-readable storage media (e.g., the memory 220), which may serve as non-transitory computer-readable storage media storing processor-executable instructions for execution by the processor 210.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or.” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first.” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including.” “comprising.” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A system for managing script execution by a browser, the system comprising:
at least one processor;
a memory operatively coupled to the at least one processor;
the at least one processor when executing configured to:
instantiate a sandboxed environment including at least a proxy layer for managing resource requests;
execute the browser within the sandboxed environment and respective site code;
capture information on any resource requests made by the browser;
validate operation and any resource requests based on a system defined security or privacy policy; and
generate a secure signature for the browser and/or script or a validation log of the resource requests made by the browser, responsive to validation of operation.

2. The system of claim 1, wherein the system is further configured to generate a secure signature for scripts under test responsive to validation of operation.

3. The system of claim 1, wherein the system is further configured to generate a secure signature for the browser responsive to validation of operation.

4. The system of claim 1, wherein the at least one processor is further configured to evaluate any access points targeted, resource requested, communication calls, operating system requests, privilege change, memory requests inconsistent with prior operation, as specified by the security or the privacy policy.

5. The system of claim 1, wherein the at least one processor is further configured to evaluate any access points targeted, resource requested, communication calls, operating system requests, privilege change, memory requests inconsistent with prior operation, as defined by default system parameters.

6. The system of claim 1, wherein the at least one processor is configured to obscure any operations executed under the management of the proxy layer.

7. The system of claim 6, wherein the at least one processor is configured to return results of new operations in the site code based on specification in any original code of the new operations.

8. The system of claim 1, wherein the at least one processor is configured to analyze any code associated with a new operation in associated site code based on known vulnerability exploits and custom execution targets.

9. The system of claim 1, wherein the proxy layer is further configured to manage execution of any operations performed by the site code based on javascript, document object model (“DOM”) specification, network operations.

10. The system of claim 9, wherein the at least one processor is configured to analyze new operations in the site code using similarity to historic operations, including similarity to access points, DOM element access, operating system calls, and network requests.

11. A computer implemented method for managing script execution by a browser, the method comprising:
instantiating, by the at least one processor, e a sandboxed environment including at least a proxy layer for managing resource requests;
executing, by the at least one processor, the browser within the sandboxed environment and respective site code;
capturing, by the at least one processor, information on any resource requests made by the browser;
validating, by the at least one processor, operation and any resource requests based on a system defined security or privacy policy; and
generating, by the at least one processor, a secure signature for the browser and/or script or a validation log of the resource requests made by the browser, responsive to validation of operation.

12. The method of claim 11, wherein the method further comprises generating a secure signature for scripts under test responsive to validation of operation.

13. The method of claim 11, wherein the method further comprises generating a secure signature for the browser responsive to validation of operation.

14. The method of claim 11, wherein the method further comprises evaluating any access points targeted, resource requested, communication calls, operating system requests, privilege change, memory requests inconsistent with prior operation, as specified by the security or the privacy policy.

15. The method of claim 11, wherein the method further comprises evaluating any access points targeted, resource requested, communication calls, operating system requests, privilege change, memory requests inconsistent with prior operation, as defined by default system parameters.

16. The method of claim 11, wherein the method further comprises obscuring any operations executed under the management of the proxy layer.

17. The method of claim 16, wherein the method further comprises returning results of new operations in the site code based on specification in any original code of the new operations.

18. The method of claim 11, wherein the method further comprises analyzing any code associated with a new operation in associated site code based on known vulnerability exploits and custom execution targets.

19. The method of claim 11, wherein the method further comprises managing execution of any operations performed by the site code based on javascript, document object model (“DOM”) specification, and network operations.

20. The method of claim 19, wherein the method further comprises analyzing new operations in the site code using similarity to historic operations, including similarity to any one of: access points, DOM element access, operating system calls, or network requests.
